(19) United States
(12) Patent Application Publication
(10) Pub. No.: US 2007/0146826 A1
(43) Pub. Date: Jun. 28, 2007

(54) Image forming apparatus, image forming unit, replacement method for image forming unit, and manufacturing method for image forming unit

(75) Inventors: Tsukasa Inao, Kanagawa (JP); Atsuyuki Kitamura, Kanagawa (JP); Masahiro Sato, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/488,090

(22) Filed: Jul. 18, 2006

(30) Foreign Application Priority Data
Dec. 26, 2005 (JP) P2005-372369

(51) Int. Cl. G06K 15/00

(52) U.S. Cl. 358/498; 358/1.14

(57) ABSTRACT

An image forming apparatus includes an image forming unit detachably attached to an image forming apparatus. The image forming unit includes a first unit that accommodates a first process device, and a second unit that is detachable from the first unit and accommodates a second process device with a longer life than the first process device.

### BACKGROUND

1. Technical Field

The present invention relates to an image forming apparatus, an image forming unit, a replacement method for an image forming unit, and a manufacturing method for an image forming unit.

2. Related Art

As an image forming apparatus, a technology wherein an image forming unit is detachable from an image forming apparatus main body is known. According to the technology, for example, a user is able to easily replace the image forming unit and the time for part replacement can be made shorter.

However, since the conventional technology is to replace all parts that form the image forming unit at the same time when replacing the image forming unit, there has been a problem that, when there is only one part in need of replacement, all parts including the other parts with no need of replacement must be replaced at once.

### SUMMARY

According to an aspect of the invention, an image forming apparatus includes an image forming unit detachably attached to an image forming apparatus. The image forming unit includes a first unit that accommodates a first process device, and a second unit that is detachable from the first unit and accommodates a second process device with a longer life than the first process device.

### BRIEF DESCRIPTION OF THE DRAWINGS

Exemplary embodiments of the present invention will be described in detail based on the following figures, wherein:

FIG. 1 is a side view showing the schematic configuration of the image forming apparatus according to the first exemplary embodiment of the invention;

FIG. 2 is a side view showing the configuration of the image forming unit used in the image forming apparatus according to the first exemplary embodiment of the invention;

FIG. 3 is an explanatory diagram showing the condition in which the image forming unit used in the image forming apparatus according to the first exemplary embodiment of the invention is separated into the photoconductor unit and the developing unit;

FIG. 4 is a side view showing the configuration of the image forming unit used in the image forming apparatus according to the second exemplary embodiment of the invention; and

FIG. 5 is an explanatory diagram showing the condition in which the image forming unit used in the image forming apparatus according to the second exemplary embodiment of the invention is separated into the photoconductor unit, the developing unit, and the exposure unit.

### DETAILED DESCRIPTION

Next, exemplary embodiments of the invention will be described based on the drawings.

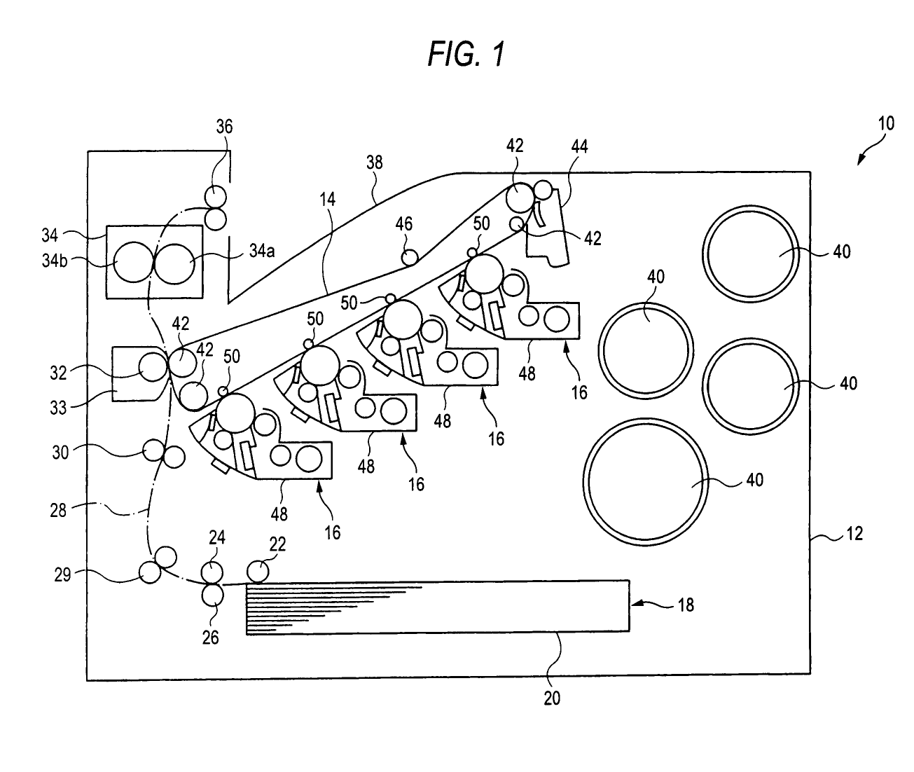

In FIG. 1, an image forming apparatus 10 according to an exemplary embodiment of the invention is shown. The image forming apparatus 10 has an image forming apparatus main body 12, and an intermediate transfer belt 14 is provided within the image forming apparatus main body 12. For example, four image forming devices 16 are arranged in parallel to the intermediate transfer belt 14, and the image forming apparatus 10 is in a so-called tandem system. The image forming devices 16 respectively form toner images of the respective colors or yellow, magenta, cyan, and black on the intermediate transfer belt 14.

A sheet feed device 18 is provided in the lower part of the image forming apparatus main body 12. The sheet feed device 18 has a sheet feed cassette 20 in which sheets are stacked, a pickup roll 22 that picks up sheets stacked in the sheet feed cassette 20, and a feed roll 24 and a retard roll 26 that separately send out the sheets. The sheet feed cassette 20 is detachably provided to the image forming apparatus main body 12 so as to be pulled out frontward in the drawing, and sheets such as plain paper and OHP sheets that are transfer materials are stacked and accommodated.

A sheet feed path 28 is provided along the substantially vertical direction near one end of the image forming apparatus main body 12 (near the left end in the drawing). In the sheet feed path 28, a transport roll 29, a resist roll 30, a second transfer roll 32, a fixing device 34, and an eject roll 36 are provided. The resist roll 30 temporarily stops the sheet send out into the sheet feed path 28 and instead sends it to the second transfer roll 32 with timing. The fixing device 34 includes a heat roll 34a and a pressure roll 34b and is arranged to fix a toner image on the sheet by applying heat and pressure to the sheet passing between the heat roll 34a and the pressure roll 34b.

An eject tray part 38 is provided in the upper part of the image forming apparatus main body 12. The sheet on which the toner image has been fixed is ejected to the eject tray part 38 by the above described eject roll 36, and stacked in the eject tray part 38. Accordingly, the sheets in the sheet feed cassette 20 are sequentially ejected through the C-shaped path to the eject tray part 38.

At the other end of the image forming apparatus main body 12 (at the right end side in the drawing), f or example, four toner bottles 40 are provided. The toner bottles 40 accommodate the respective toner of yellow, magenta, cyan, and black, and are arranged to supply toner to the image forming devices 16 via toner supply paths (not shown).

The intermediate transfer belt 14 is supported by plural transport rolls 42, and the belt face on which the above described image forming devices 16 are provided is slanted relative to the horizontal direction. One of the transport rolls 42 forms a backup roll of the second transfer roll 32. Further, near the upper end of the intermediate transfer belt 14, a cleaning device 44 for intermediate transfer belt is provided and the other one of the transfer rolls 42 forms a backup roll of the cleaning device 44. Furthermore, above the intermediate transfer belt 14, a tension roll 46 is provided and appropriate tension is provided to the intermediate transfer belt 14 by the tension roll 46.

The image forming devices 16 include an image forming unit 48 provided at one face of the intermediate transfer belt 14 and a first transfer roll 50 provided on the rear side of the intermediate transfer belt 14. The image forming unit 48 is detachable from the image forming apparatus main body 12, and arranged so as to be pulled out frontward in the drawing after once moved downward.

On the other hand, the sheets stacked in the sheet feed cassette 20 of the sheet feed device 18 are sent out to the sheet feed path 28 one by one by the pickup roll 22, the feed roll 24, the retard roll 26, etc. The sheet sent out into the sheet feed path 28 is brought into contact with the resist roll 30, temporarily stopped, and transported to the second transfer roll 32 with timing. Then, the toner image on the intermediate transfer belt 14 is transferred to the sheet by the second transfer roll 32. The sheet to which the toner image has been transferred is further transported to the fixing device 34, and the toner image is fixed to the sheet by heat and pressure. The sheet to which the toner image has been fixed by the fixing device 34 is ejected by the eject tray part 38 by the eject roll 36.

In such an image forming apparatus 10, there has been a problem that, when the image forming unit 48 is replaced, all parts that form the image forming unit 48 must be replaced at the same time. In the exemplary embodiment, a part that forms the image forming unit 48 can be selectively replaced by modifying the configuration of the image forming unit 48.

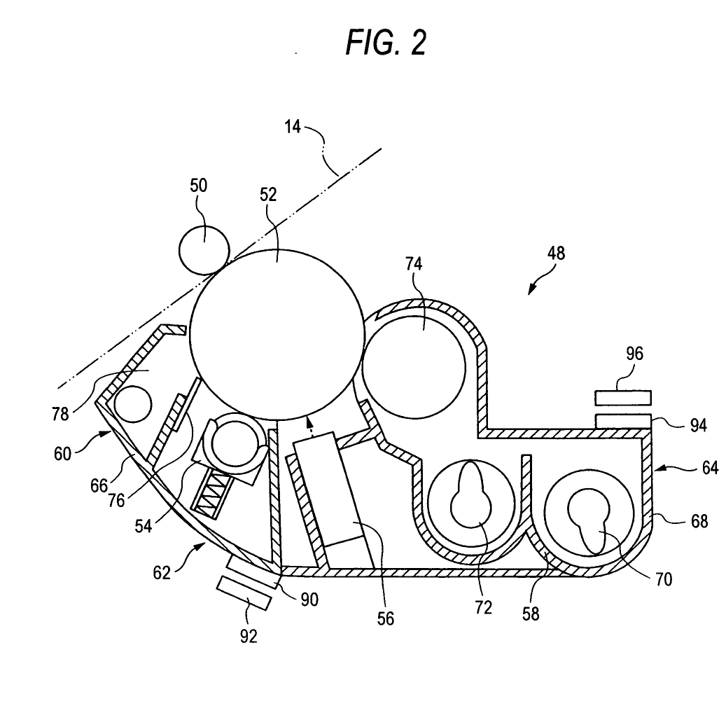

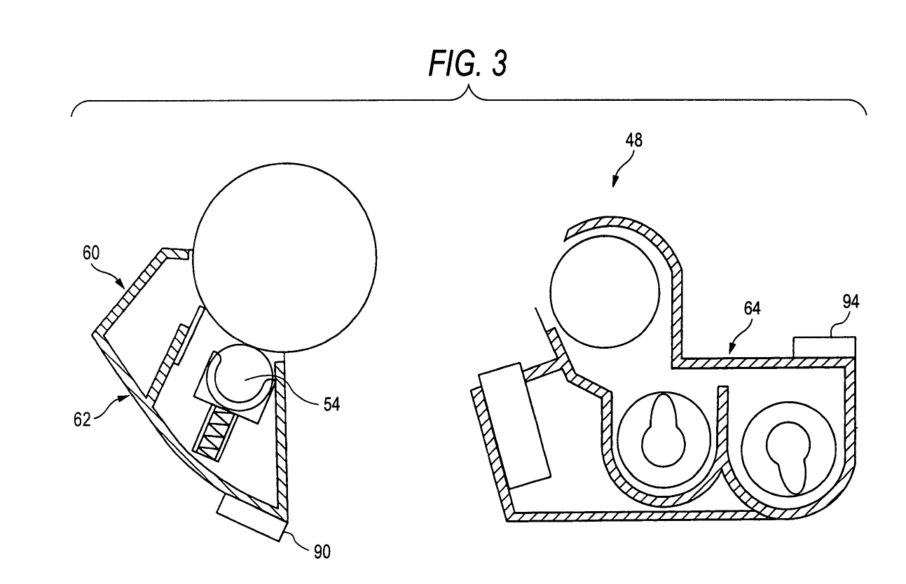

In FIGS. 2 and 3, details of the image forming unit 48 according to the first exemplary embodiment are shown. The image forming unit 48 has a photoconductor 52 facing the intermediate transfer belt 14, a charging device 54 including a roll, for example, for charging the photoconductor 52, a latent image forming device 56 including an LED (light emitting diode), for example, for forming a latent image on the surface of the photoconductor 52 by exposure, a developing device 58 for developing the latent image formed on the photoconductor 52 by the latent image forming device 56 with toner, and a cleaning device 60 for cleaning the toner left on the photoconductor 52 after transfer.

In the exemplary embodiment, the image forming unit 48 includes a photoconductor unit 62 used as a first unit and a developing unit 64 used as a second unit that are separably coupled. The photoconductor unit 62 accommodates the photoconductor 52, the charging device 54, and the cleaning device 60 in a first casing 66. The charging device 54 or the cleaning device 60 accommodated in the photoconductor unit 62 is used as a first process device. The developing unit 64 accommodates the developing device 58 and the latent image forming device 56 in a second casing 68. The developing device 58 or the latent image forming device 56 accommodated in the developing unit is used as second process device. Further, the first casing 66 and the second casing 68 are separable as shown in FIG. 3.

The developing device 58 adopts the two-component system using developer consisting of toner and carrier, for example, has two augers 70, 72 provided in parallel to the horizontal direction and a developing roll 74 provided diagonally above the exit side auger 72, and stirs the developer with the augers 70, 72 and supplies it to the developing roll 74. On the developing roll 74, a magnetic brush of carrier is formed, the toner attached to the carrier is transported by the magnetic brush, and the latent image on the photoconductor 52 is developed with the toner. As in the exemplary embodiment, the developing roll 74 is located above the augers 70, 72 in the developing device 58 of two-component system, and thereby, accumulation of the developer is prevented. The developer can be evenly stirred and the development performance can be maintained.

The cleaning device 60 includes a toner scraping part 76 formed of a blade, for example, and a collecting part 78 for collecting the toner scraped by the toner scraping part 76.

The charging device 54 and the cleaning device 60 are process devices of abrasion type having a part that wears in contact with the rotating photoconductor 52, while the developing device 58 and the latent image forming device 56 are process devices of non-abrasion type having no part in contact with the photoconductor 52. Accordingly, the life of the developing device 58 and the latent image forming device 56 is longer than the life of the cleaning device 60 and the charging device 54. In the exemplary embodiment, as described above, the cleaning device 60 and the charging device 54 having shorter life are accommodated in the first casing 66 and integrated as the photoconductor unit 62. The developing device 58 and the latent image forming device 56 having longer life are accommodated in the second casing 68 and integrated as the developing unit 64, and the photoconductor unit 62 and the developing unit 64 are arranged detachably. Accordingly, it is not necessary to replace the entire image forming unit 48 when replacing the image forming unit 48, and only one of the photoconductor unit 62 and the developing unit 64 can be replaced. For example, when the charging device 54 reaches the end of its life but the developing device 58 and the latent image forming device 56 have not reached the end of their life, only the photoconductor unit 62 that accommodates the charging device 54 can be replaced.

In the photoconductor unit 62, a first memory chip 90 used as first memory and first transmitting device is mounted, and a first antenna 92 used as first receiving device for receiving information stored in the first memory chip 90 is provided in a position opposed to the first memory chip 90 in the image forming apparatus main body 12. In the first memory chip 90, information on the use history such as the number of times of use and periods of use with respect to the photoconductor 52, information on the use history of the cleaning device 60, information on the use history of the charging device 54, etc. are stored, and the information is transmitted to the first antenna 92. The first antenna 92 receives the information sent from the first memory chip 91, and transmits the received information to the controller (not shown) that controls the image formation process conditions based on the information.

In the developing unit 64, a second memory chip 94 used as second memory and second transmitting device is mounted, and a second antenna 96 used as second receiving device for receiving information stored in the second memory chip 94 is provided in a position opposed to the second memory chip 94 in the image forming apparatus main body 12. In the second memory chip 94, information on the use history such as the number of times of use and periods of use with respect to the developing device 58, information on the use history of the latent image forming device 56, information on the irregularities in amounts of light of the latent image forming device 56, etc. are stored, and the information is transmitted to the second antenna 96. The second antenna 96 receives the information sent from the second memory chip 94, and transmits the received information to the controller (not shown) that controls the image formation process conditions based on the information. In the exemplary embodiment, transmission and reception of information between the first memory chip 90 and the first antenna 92 are wirelessly performed. However, the first memory chip 90 and the first antenna 92 may be connected by a signal line for transmitting and receiving information.

In the above configuration, the intermediate transfer belt 14 and the photoconductor 52 rotate in synchronization in opposite directions to each other. The surface of the photoconductor 52 is charged by the charging device 54 and a latent image is formed by the latent image forming device 56. The latent image on the photoconductor 52 formed by the latent image forming device 56 is developed by the developing device 58. The toner image developed by the developing device 58 is transferred to the intermediate transfer belt 14 by the first transfer roll 50. The toner images of the respective colors formed by the respective image forming devices 16 are superimposed as the intermediate transfer belt 14 moves. The charging condition by the charging device 54 is transmitted from the first memory chip 90, and controlled by the controller (not shown) based on the use history of the charging device 54 received by the first antenna 92. The amount of exposure by the latent image forming device 56 is transmitted from the second memory chip 94 and corrected based on the information on the exposure irregularities received by the second antenna 96. In the exemplary embodiment, transmission and reception of information between the second memory chip 94 and the second antenna 96 are wirelessly performed. However, the second memory chip 94 and the second antenna 96 may be connected by a signal line for transmitting and receiving information.

To replace the entire image forming unit 48 mounted to the image forming apparatus main body 12 of the image forming apparatus 10, the image forming unit 48 is first moved downwardly within the image forming apparatus main body 12 and the photoconductor 52 and the intermediate transfer belt 14 are separated. Then, the image forming unit 48 is pulled out frontward in the drawing. On the other hand, to mount the entire image forming unit 48 to the image forming apparatus main body 12, the image forming unit 48 is mounted to the image forming apparatus main body 12 from the front side in the drawing. Then, the image forming unit 48 is moved upwardly and the photoconductor 52 is brought into contact with the intermediate transfer belt 14.

To replace the photoconductor unit 62 mounted to the image forming apparatus main body 12, first, the entire image forming unit 48 is pulled out from the image forming apparatus main body 12 and the pulled out image forming unit 48 is separated into the photoconductor unit 62 and the developing unit 64. Then, a new photoconductor unit 62 for replacement and the developing unit 64 pulled out from the image forming apparatus main body 12 are connected for assembly of the image forming unit 48 in which the photoconductor unit 62 is replaced. Then, the image forming unit 48 is mounted to the image forming apparatus main body 12. Further, it is possible to pull out only the photoconductor unit 62 from the image forming apparatus main body 12 while leaving the developing unit 64 in the image forming apparatus main body 12 when a new photoconductor unit 62 is mounted to the image forming apparatus main body 12.

When the developing unit 64 mounted to the image forming apparatus main body 12 is replaced, the entire image forming unit 48 is pulled out from the image forming apparatus main body 12. The image forming unit 48 is assembled by a developing unit 64 for replacement and the photoconductor unit 62 pulled out from the image forming apparatus main body 12, and then, the image forming unit 48 is mounted to the image forming apparatus main body 12. Further, it is possible to pull out only the developing unit 64 from the image forming apparatus main body 12 while leaving the photoconductor unit 62 in the image forming apparatus main body 12 when a new developing unit 64 is mounted to the image forming apparatus main body 12.

The image forming unit 48, the photoconductor unit 62, and the developing unit 64 taken out from the image forming apparatus main body 12 are collected and reconditioned. To recondition the photoconductor unit 62, for example, the worn charging device 54 is replaced. When the photoconductor unit 62 is reconditioned, parts to be replaced are determined based on the use history of the photoconductor 52, the use history of the cleaning device 60, and the use history of the charging device 54 stored in the first memory chip 90. Further, to recondition the developing unit 64, for example, the developing device 58 that has reached the end of its life is replaced. When the developing unit 64 is reconditioned, parts to be replaced are determined based on the use history of the latent image forming device 56 and the use history of the developing device 58 stored in the second memory chip 94.

The reconditioned photoconductor unit 62 and developing unit 64 are respectively shipped as single units for replacement. Furthermore, the reconditioned photoconductor unit 62 and the reconditioned developing unit 64 are combined for manufacturing a new image forming unit 48. An image forming unit 48 may be manufactured using a reconditioned unit for one of the photoconductor unit 62 of the developing unit 64, and a newly manufactured unit for the other unit.

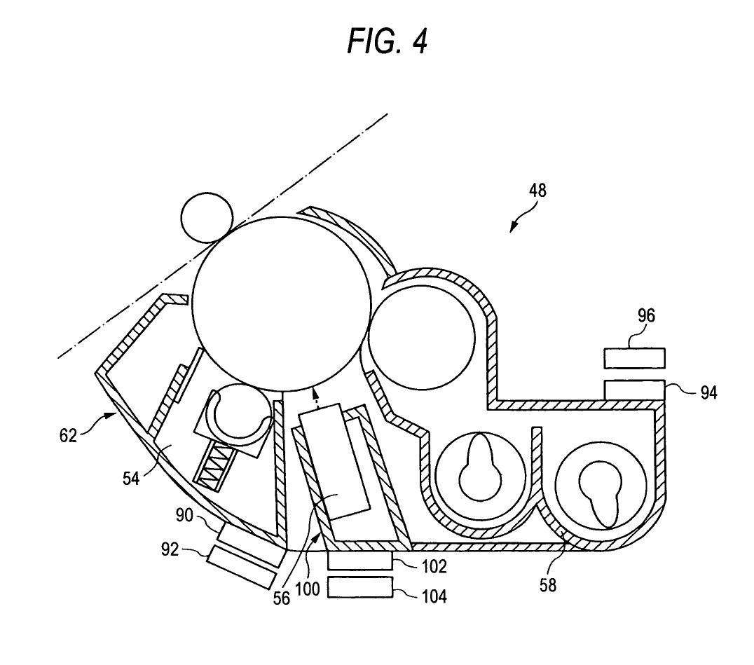

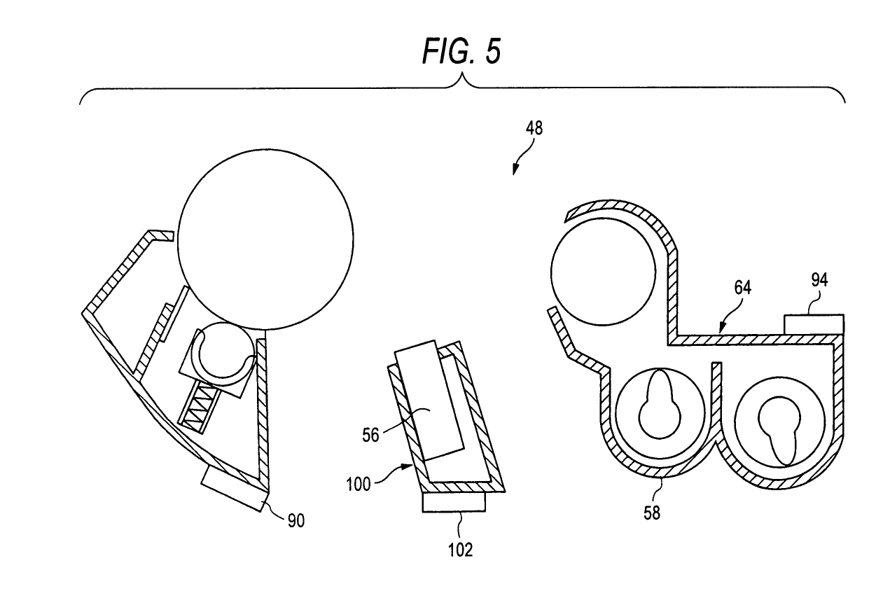

In FIGS. 4 and 5, details of an image forming unit 48 according to the second exemplary embodiment are shown. In comparison with the above described first exemplary embodiment, while the image forming unit 48 is formed by the two units of the photoconductor unit 62 and the developing unit 64 in the first exemplary embodiment, the image forming unit 48 is formed by the three units of the photoconductor unit 62, the developing unit 64, and a latent image forming unit 100 in this exemplary embodiment. The photoconductor unit 62, the developing unit 64, and the latent image forming unit 100 are separable from one another as shown in FIG. 5.

The device life of the latent image forming device 56 accommodated in the latent image forming unit 100 is longer than the device life of the developing device 58 accommodated in the developing unit 64. Thus, the image forming unit 48 is formed of three units separable from one another based on the length of the device life of the latent image forming unit 100 accommodating: the latent image forming device 56 having the longest device life, the developing unit 64 accommodating the developing device 58 having the next longest device life, and the photoconductor unit 62 accommodating the cleaning device and the charging device having the shortest device life. Accordingly, when the image forming unit 48 is replaced, the entire image forming unit 48 is not necessarily replaced, and only a unit accommodating the device that has reached the end of its life can be selectively replaced from among the photoconductor unit 62, the developing unit 64, and the latent image forming unit 100.

In the second exemplary embodiment, in the latent image forming unit 100, a third memory chip 102 used as third memory and a third transmitting device is mounted, and a third antenna 104 used as a third receiving device for receiving information stored in the third memory chip 102 is provided in a position opposed to the third memory chip 102 of the image forming apparatus main body 12. In the third memory chip 102, information on the use history of the latent image forming device 56, information on the irregularities in amounts of light of the latent image forming device 56, etc. that has been stored in the second memory chip 94 in the first exemplary embodiment are stored, and the information is transmitted to the third antenna 104. The third antenna 104 receives the information received from the third memory chip, and transmits the received information to the controller (not shown) that controls the image formation process conditions based on the information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit detachably attached to an image forming apparatus, the image forming unit comprising:
a first unit that accommodates a first process device, and
a second unit that is detachable from the first unit and accommodates a second process device with a longer life than the first process device.

2. The image forming apparatus according to claim 1, wherein
the first unit comprises a first memory that stores at least information on the first process device, and the second unit comprises a second memory that stores at least information on the second process device.

3. The image forming apparatus according to claim 2, wherein
the information stored in the first memory includes at least a use history of the first process device, and the information stored in the second memory includes at least a use history of the second process device.

4. The image forming apparatus according to claim 2, wherein
the first unit further comprises a first transmitting device that transmits the information stored in the first memory and the second unit further comprises a second transmitting device that transmits the information stored in the second memory, and
the image forming apparatus further comprises:
a first receiving device that receives the information transmitted from the first transmitting device; and
a second receiving device that receives the information transmitted from the second transmitting device.

5. The image forming apparatus according to claim 4, wherein
the transmission and reception of information between the first and second transmitting devices and the first and second receiving devices are wired or wireless communication.

6. The image forming apparatus according to claim 1, wherein
the image forming unit further comprises a third unit that accommodates a third process device with a longer life than the first process device and the second process device and is detachable from the first unit and the second unit.

7. The image forming apparatus according to claim 6, wherein
the third unit comprises a third memory that stores at least information on the third process device.

8. The image forming apparatus according to claim 7, wherein
the information stored in the third memory includes at least a use history of the third process device.

9. The image forming apparatus according to claim 7, wherein
the third unit further comprises a third transmitting device that transmits the information stored in the third memory, and
the image forming apparatus further comprises:
a third receiving device that receives the information transmitted from the third transmitting device.

10. The image forming apparatus according to claim 9, wherein
the transmission and reception of information between the third transmitting device and the third receiving device are wired or wireless communication.

11. The image forming apparatus according to claim 1, wherein
the first process device includes at least an image carrier and a charging device that charges the image carrier, and the second process device includes at least a developing device that develops a latent image formed on a surface of the image carrier using a developer.

12. The image forming apparatus according to claim 1, wherein
the first process device includes at least an image carrier and a cleaning device that cleans a surface of the image carrier, and the second process device includes at least a developing device that develops a latent image formed on the surface of the image carrier using a developer.

13. The image forming apparatus according to claim 11, wherein
the third process device includes at least a latent image forming device that forms the latent image on the surface of the image carrier by exposure.

14. The image forming apparatus according to claim 1, wherein
the first process device includes at least an image carrier and a charging device that charges the image carrier, and the second process device includes a latent image forming device that forms a latent image on a surface of the image carrier by exposure.

15. The image forming apparatus according to claim 1, wherein
the first process device includes at least an image carrier and a cleaning device that cleans a surface of the image carrier, and the second process device includes a latent image forming device that forms a latent image on the surface of the image carrier by exposure.

16. An image forming unit comprising:
a first unit that accommodates a first process device; and
a second unit that is detachable from the first unit and accommodates a second process device with a longer life than the first process device.

17. A replacement method for an image forming unit, comprising:
replacing at least one of a first unit and a second unit that constitute the image forming unit, the first unit being detachably attached to an image forming apparatus and accommodating a first process device, and the second unit being detachable from the first unit and accommodating a second process device having a longer life than the first process device.

18. A manufacturing method for an image forming unit, comprising:
manufacturing at least one of a first unit and a second unit that constitute the image forming unit, the first unit being detachably attached to an image forming apparatus and accommodating a first process device, and the second unit being detachable from the first unit and accommodating a second process device having a longer life than the first process device, using at least one of a first unit and a second unit having been collected and reconditioned.
